(19) United States
(12) Patent Application Publication
(10) Pub. No.: US 2026/0077615 A1
(43) Pub. Date: Mar. 19, 2026

(54) Adjustable Trophy Wall Mount

(71) Applicants: Daine Dixon, Willard, UT (US); Kyle James Fellenz, Tremonton, UT (US)

(72) Inventors: Daine Dixon, Willard, UT (US); Kyle James Fellenz, Tremonton, UT (US)

(21) Appl. No.: 19/333,051

(22) Filed: Sep. 18, 2025

Related U.S. Application Data
(63) Continuation-in-part of application No. 29/967,314, filed on Oct. 9, 2024.
(60) Provisional application No. 63/696,214, filed on Sep. 18, 2024.

(51) Int. Cl. B44C 5/02; F16M 11/14

(52) U.S. Cl. CPC B44C 5/02; F16M 11/14

(57) ABSTRACT

An adjustable trophy wall mount is a device designed to support hunting trophies or other objects that can be displayed on a wall. The device includes a first wall support, a second wall support, a fulcrum ball, a support hook, and a ball-adjustment mechanism. The first wall support and the second wall support are designed to allow the device to be secured to the desired wall. The first wall support and the second wall support also support the ball-adjustment mechanism and the controlled rotation of the fulcrum ball. The fulcrum ball rotatably connects to the support hook to the first wall support and the second wall support. The ball-adjustment mechanism allows the orientation of the support hook to be changed by enabling the rotation of the fulcrum ball. The support hook is designed to engage a portion of the trophy so that the trophy can be displayed on the wall.

The current application claims a priority to the U.S. provisional patent application Ser. No. 63/696,214 filed on Sep. 18, 2024.

The current application is also a continuation-in-part (CIP) application of the U.S. design application Ser. No. 29/967,314 filed on Oct. 9, 2024.

### FIELD OF THE INVENTION

The present invention relates generally to wall mounts and adjustable hangers. More specifically, the present invention discloses an adjustable wall mount for hunting trophies that allows the selected trophy to be displayed in the desired position and/or orientation on the wall.

### BACKGROUND OF THE INVENTION

Nowadays, different wall mounts are available that enable the display of hunt trophies. In general, most wall mounts and similar hanging devices include a structure that can be fastened to a wall from which the hunt trophy is to be displayed. In addition, these devices include a mechanism that engages with a portion of the hunt trophy so that the hunt trophy hangs from the mount device. While practical, the currently available wall mounts have several limitations. For example, most of these devices have a fixed configuration that holds the trophy at a fixed orientation relative to the wall to which the device is fastened to. Some wall mounts can include an adjustable structure to give the user more control over how the trophy is displayed. However, the mechanisms utilized for these adjustable wall mounts can be cumbersome to use and/or may require the device to be removed from the wall for adjustment. Therefore, an adjustable trophy wall mount that is easy to use and can be easily adjusted would be beneficial.

The objective of the present invention is to provide an adjustable trophy wall mount that can be adjusted to change the angle at which the hunt trophy is displayed. The present invention includes a ball-adjustment mechanism that can be selectively configured to change the orientation of a hook that engages the hunt trophy. The ball-adjustment mechanism allows the hunt trophy to be oriented into different vertical and horizontal positions. Another objective of the present invention is to provide an adjustable trophy wall mount that can be adjusted without having to be removed from the wall. The present invention can be fastened to the desired wall without obstructing access to the ball-adjustment mechanism so that the user can adjust the orientation of the hook incorporated into the ball-adjustment mechanism. Additional features and benefits of the present invention are further discussed in the sections below.

### SUMMARY OF THE INVENTION

The present invention provides an adjustable trophy wall mount. The adjustable trophy wall mount is designed for hanging and displaying hunting trophies, especially European skull mounts for display on the wall. The present invention can be manufactured using injection molding and includes a ball-adjustment mechanism, a first wall support, a second wall support, a fulcrum ball, and a support hook. The first wall support the second wall support correspond to two elongated structures connected to each other using the fulcrum ball and the ball-adjustment mechanism at one end. The other end of the first wall support the second wall support is left free to be fastened to a wall.

Further, the support hook is incorporated onto the fulcrum ball so that the orientation of the support hook can be adjusted by manipulating the ball-adjustment mechanism. The ball-adjustment mechanism can include different fastening mechanisms that allow the user to manipulate the angular position of the fulcrum ball to change the orientation of the hook. For example, the ball-adjustment mechanism can allow the hook to be tilted vertically in a fixed angle range (e.g., 30-40 degrees relative to the wall). Thus, the present invention allows the trophy to be manipulated into different vertical and horizontal positions and/or orientations for display on the desired wall.

### BRIEF DESCRIPTION OF THE DRAWINGS

FIG. 1 is a top-front-left perspective view of the present invention.

FIG. 2 is a bottom-front-left perspective view of the present invention.

FIG. 3 is a top-rear-right perspective view of the present invention.

FIG. 4 is a bottom-rear-right perspective view of the present invention.

FIG. 5 is a front view of the present invention.

FIG. 6 is a vertical cross-sectional view of the present invention taken along line 6-6 in FIG. 5.

FIG. 7 is a front view of the present invention, wherein the support hook has been tilted upwards using the ball-adjustment mechanism.

FIG. 8 is a vertical cross-sectional view of the present invention taken along line 8-8 in FIG. 7.

FIG. 9 is a top-front-left exploded perspective view of the present invention.

FIG. 10 is a bottom-rear-right exploded perspective view of the present invention.

FIG. 11 is a left view of the present invention, wherein the present invention is shown with a tethering hole.

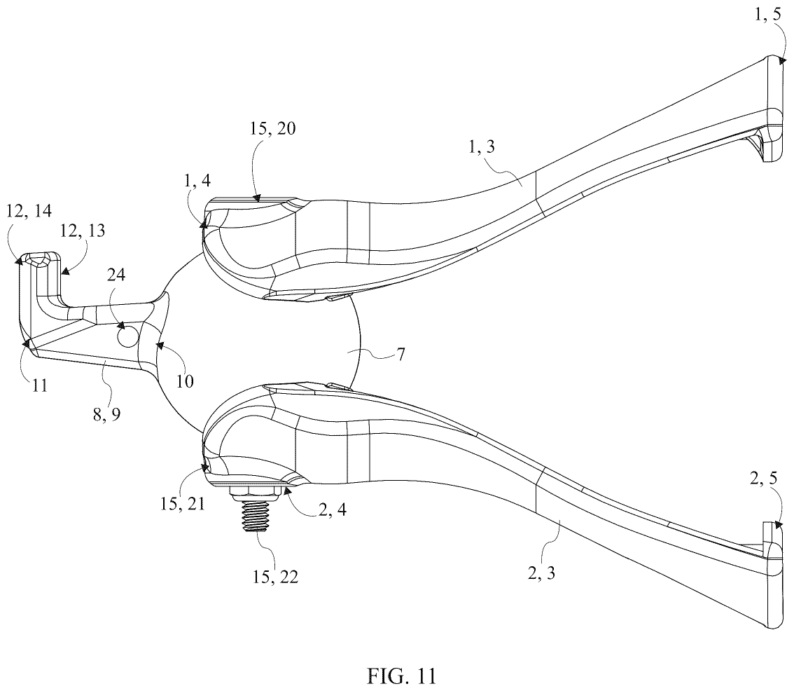

FIG. 12 is a top view of the present invention, wherein the present invention is shown with a mounting wire.

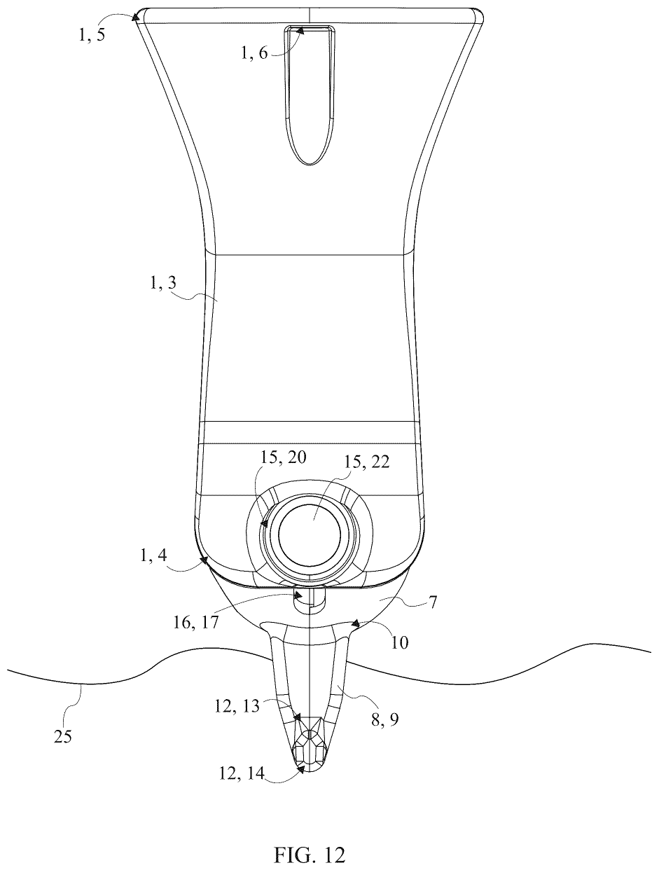

### DETAILED DESCRIPTION OF THE INVENTION

All illustrations of the drawings are for the purpose of describing selected versions of the present invention and are not intended to limit the scope of the present invention.

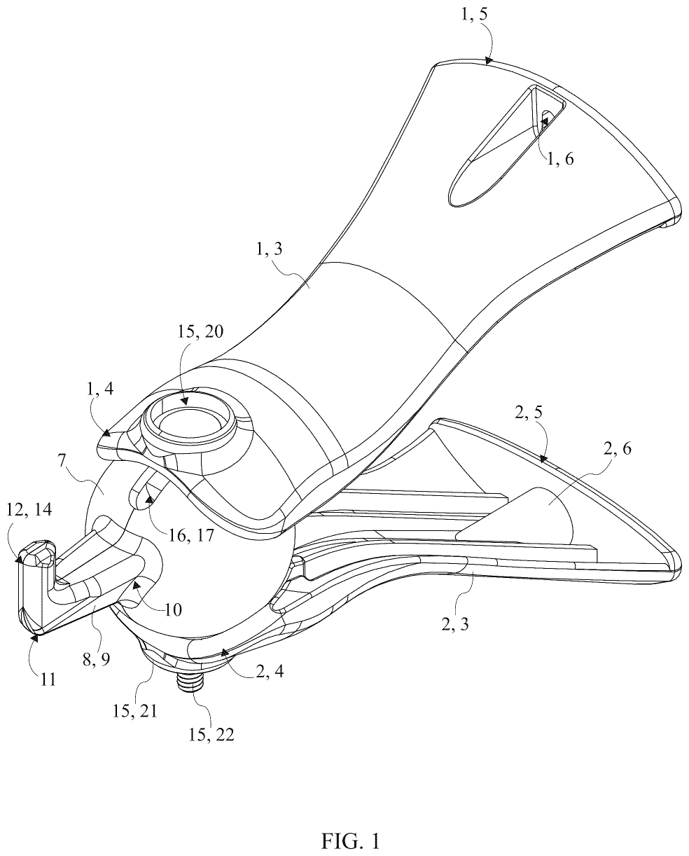

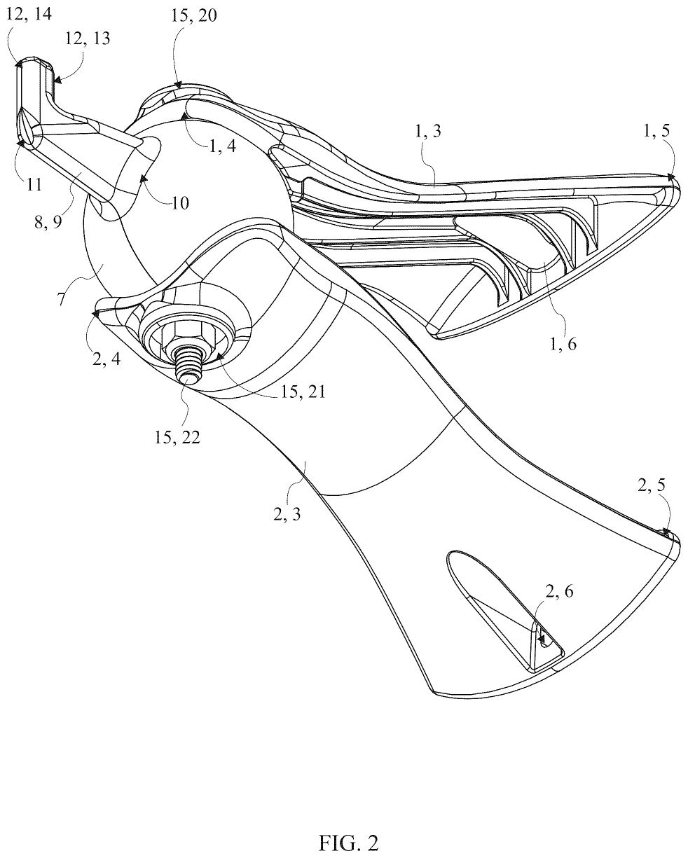

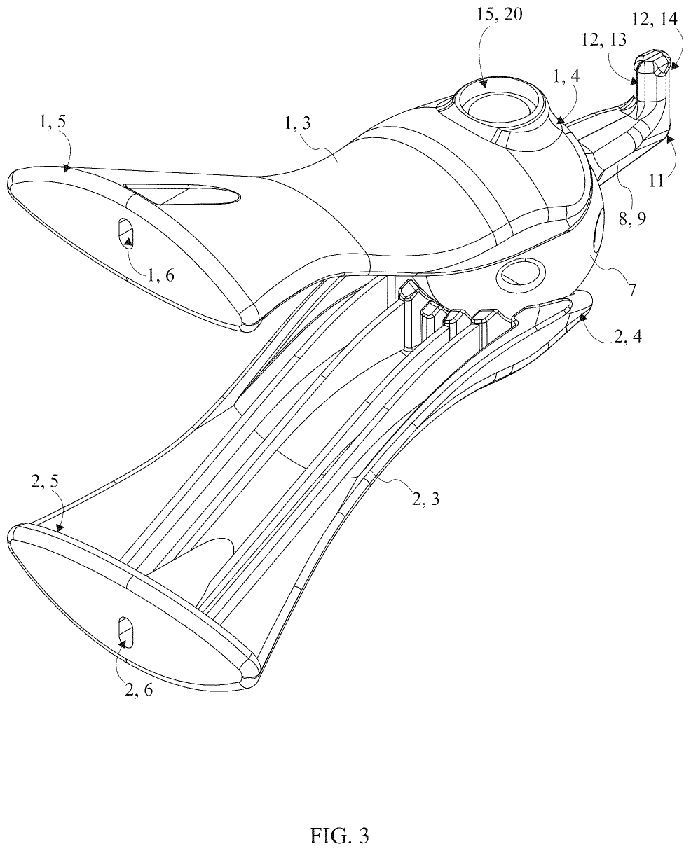

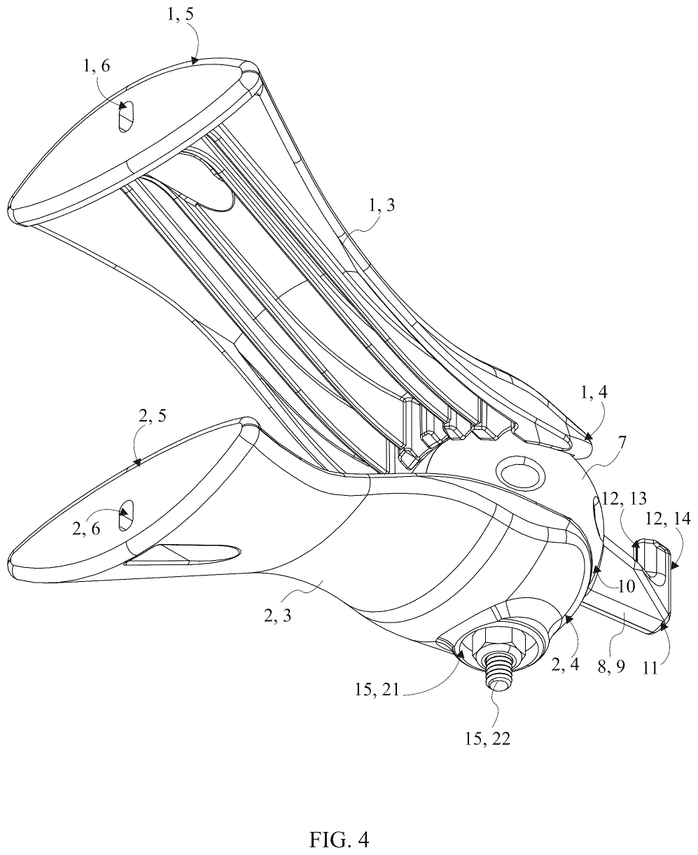

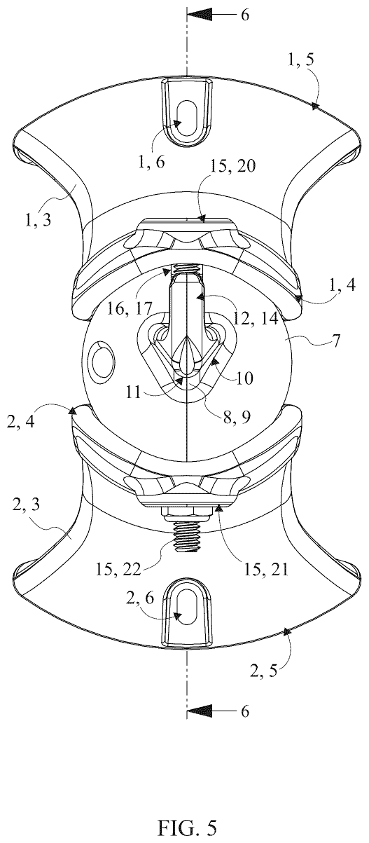

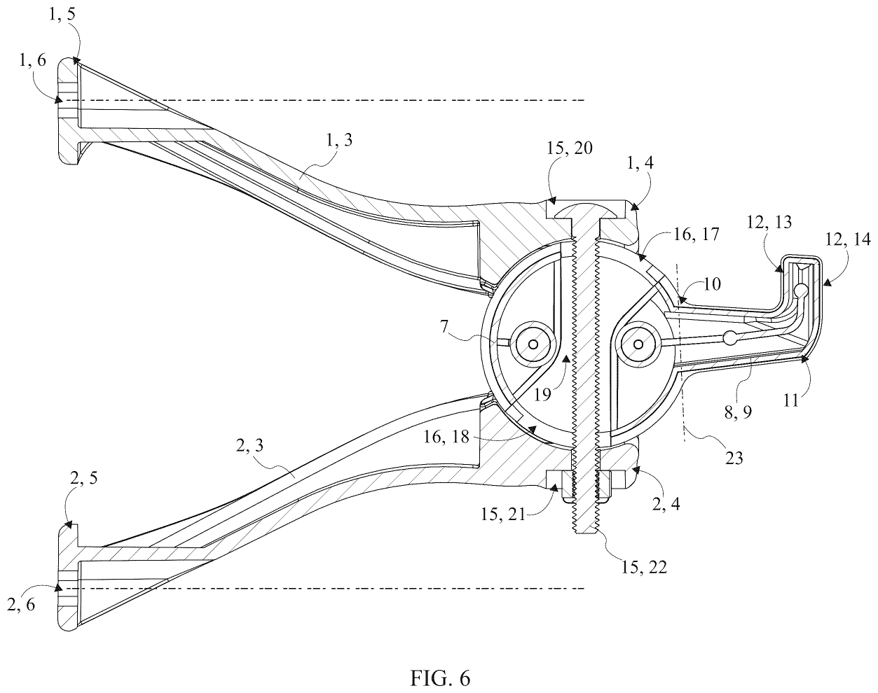

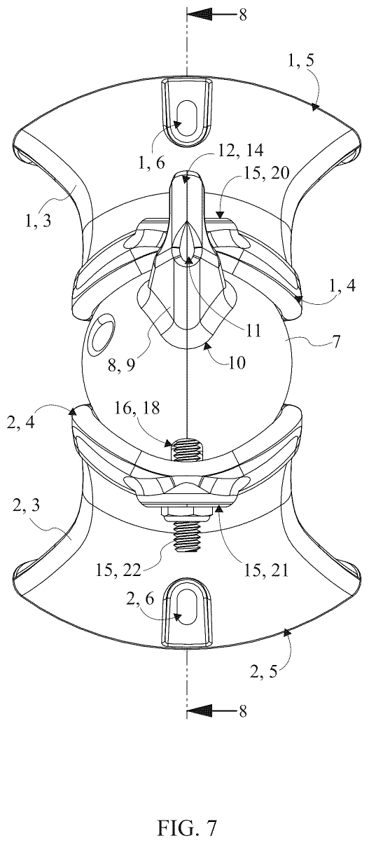

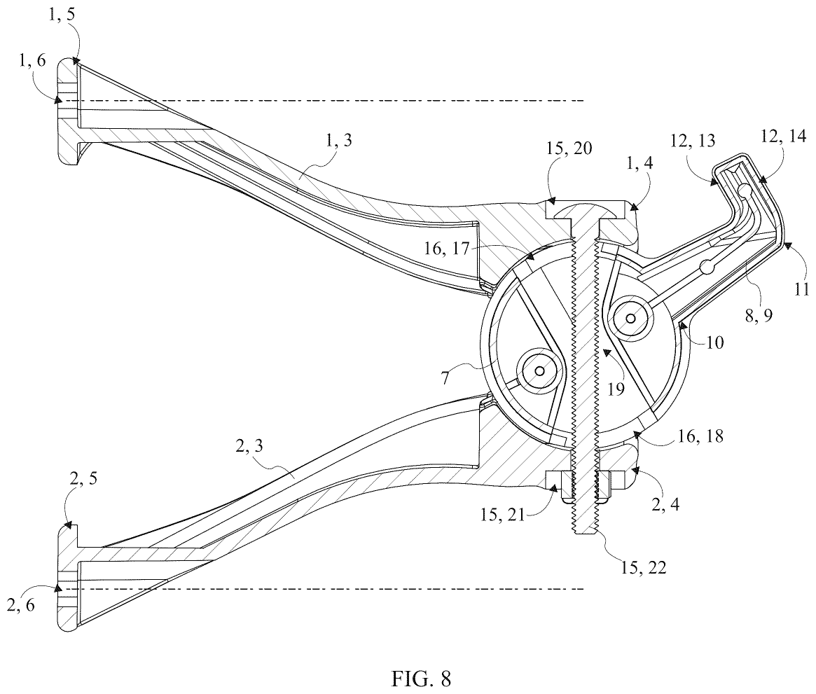

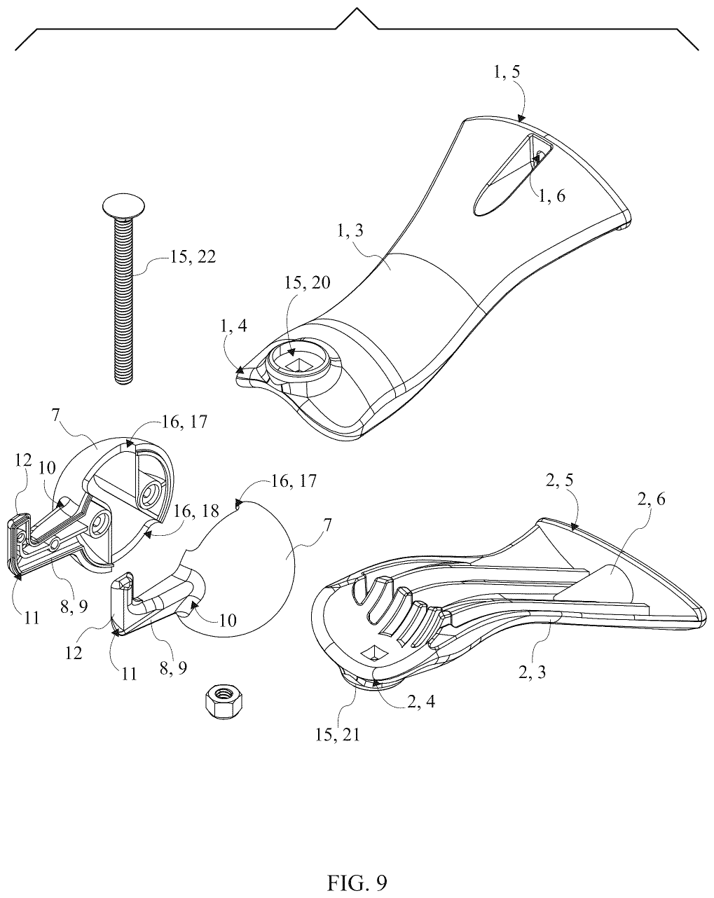

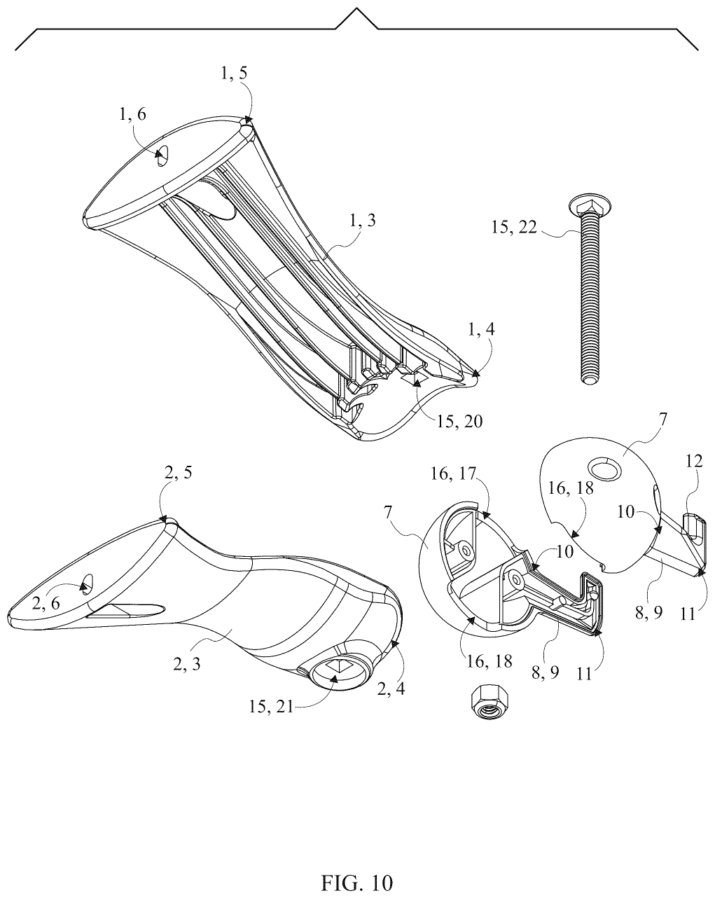

The present invention discloses an adjustable trophy wall mount. The adjustable trophy wall mount is designed to support hunting trophies or other objects that can be displayed on a wall. As can be seen in FIGS. 1 through 10, the present invention comprises a first wall support 1, a second wall support 2, a fulcrum ball 7, a support hook 8, and a ball-adjustment mechanism 15. The first wall support 1 and the second wall support 2 are designed to allow the present invention to be secured to the desired wall. The first wall support 1 and the second wall support 2 also support the operation of the ball-adjustment mechanism 15 and the controlled rotation of the fulcrum ball 7. The fulcrum ball 7 rotatably connects to the support hook 8 to the first wall support 1 and the second wall support 2. The ball-adjustment mechanism 15 allows the user to change the orientation of the support hook 8 by enabling the rotation of the fulcrum ball 7. The support hook 8 is designed to securely engage a portion of the trophy so that the trophy can be displayed in the desired position and/or orientation.

The general configuration of the aforementioned components allows the user to display a trophy from a wall in the desired position and/or orientation without the use of multiple fasteners and mounting accessories. As can be seen in FIGS. 1 through 10, the first wall support 1 and the second wall support 2 correspond to two elongated structures with mirror designs that are positioned in a mirrored configuration across the fulcrum ball 7. The first wall support 1 and the second wall support 2 have a shape and size designed to support a predetermined load range. For example, longer and wider wall supports can be implemented for larger and heavier hunting trophies, while shorter and thinner wall supports can be implemented for smaller and lighter hunting trophies.

In general, the first wall support 1 and the second wall support 2 each comprises an elongated support body 3, a proximal support end 4, and a distal support end 5, as can be seen in FIGS. 1 through 10. The elongated support body 3 corresponds to the main structure of each wall support and is preferably a curved, wide body long enough to support the load of the trophy being supported. Different shapes or ornamental designs can be implemented on the elongated support body 3 to support different trophies or objects to be displayed. Further, the proximal support end 4 and the distal support end 5 correspond to the terminal ends of the elongated support body 3. The proximal support end 4 preferably corresponds to the support end that is engaged to the fulcrum ball 7, while the distal support end 5 corresponds to the support end that is fastened to the desired wall.

In the preferred embodiment, the present invention can be arranged as follows: the proximal support end 4 and the distal support end 5 is positioned opposite to each other along the elongated support body 3 due to the design of the elongated support body 3. As can be seen in FIGS. 1 through 10, the proximal support end 4 of the first wall support 1 and the proximal support end 4 of the second wall support 2 are pivotably mounted onto the fulcrum ball 7. The proximal support end 4 of the first wall support 1 and the proximal support end 4 of the second wall support 2 are arranged to form the socket structure that retains the fulcrum ball 7 and allows the rotation of the fulcrum ball 7 while adjusting the orientation of the support hook 8. Further, the proximal support end 4 of the first wall support 1 and the proximal support end 4 of the second wall support 2 are positioned opposite to each other about the fulcrum ball 7. This way, the fulcrum ball 7 is sandwiched between the proximal support end 4 of the first wall support 1 and the proximal support end 4 of the second wall support 2. In addition, the support hook 8 is connected onto the fulcrum ball 7 in between the proximal support end 4 of the first wall support 1 and the proximal support end 4 of the second wall support 2. The support hook 8 is designed so that a portion of the hunting trophy is wedged between the support hook 8 and the fulcrum ball 7. The rest of the hunting troper would hang from the support and/or rest of the adjacent surfaces of the wall.

Furthermore, the ball-adjustment mechanism 15 is operatively integrated through the proximal support end 4 of the first wall support 1, the proximal support end 4 of the second wall support 2, and the fulcrum ball 7, as can be seen in FIGS. 1 through 10. The ball-adjustment mechanism 15 is preferably a manual mechanism that can be disengaged by the user to loosen an arrangement between the proximal support end 4 of the first wall support 1, the proximal support end 4 of the second wall support 2, and the fulcrum ball 7 to adjust an orientation of the support hook 8. In other words, when the ball-adjustment mechanism 15 is disengaged, the fulcrum ball 7 is loosened and allowed to rotate between the proximal support end 4 of the first wall support 1 and the proximal support end 4 of the second wall support 2. In addition, the user can engage the ball-adjustment mechanism 15 to tighten the arrangement between the proximal support end 4 of the first wall support 1, the proximal support end 4 of the second wall support 2, and the fulcrum ball 7 to secure the support hook 8 in place. When the ball-adjustment mechanism 15 is engaged, the fulcrum ball 7 is tightened between the proximal support end 4 of the first wall support 1 and the proximal support end 4 of the second wall support 2. This prevents the rotation of the fulcrum ball 7, and the support hook 8 is locked in place.

Different types of manual mechanisms can be implemented for the ball-adjustment mechanism 15. In some embodiments, the ball-adjustment mechanism 15 comprises an hourglass-shaped channel 16, a first fastener hole 20, a second fastener hole 21, and an adjustment fastener 22, as can be seen in FIGS. 1 through 10. The hourglass-shaped channel 16 is a space formed within the fulcrum wall to receive the adjustment fastener 22. The first fastener hole 20 and the second fastener hole 21 correspond to holes on the proximal support end 4 of the first wall support 1 and the proximal support end 4 of the second wall support 2, respectively, that accommodate the adjustment fastener 22. The adjustment fastener 22 is a mechanical fastener that can be manually fastened. For example, the adjustment fastener 22 can include, but is not limited to, a nut and bolt combination.

This embodiment of the ball-adjustment mechanism 15 can be implemented as follows: the hourglass-shaped channel 16 traverses through the fulcrum ball 7 to form an hourglass-shaped space in the fulcrum ball 7 with a thickness matching the outer diameter of the adjustment fastener 22, as can be seen in FIGS. 1 through 10. In addition, the first fastener hole 20 laterally traverses through the elongated support body 3 of the first wall support 1, adjacent to the proximal support end 4 of the first wall support 1. This forms a hole with a diameter matching the outer diameter of the adjustment fastener 22 so that the adjustment fastener 22 can pass through the first wall support 1. Similarly, the second fastener hole 21 laterally traverses through the elongated support body 3 of the second wall support 2, adjacent to the proximal support end 4 of the second wall support 2. This also forms a hole with a diameter matching the outer diameter of the adjustment fastener 22 so that the adjustment fastener 22 can pass through the second wall support 2. Then, to fasten the fulcrum wall in between the first wall support 1 and the second wall support 2, the adjustment fastener 22 is positioned through the first fastener hole 20, through the hourglass-shaped channel 16, and through the second fastener hole 21. When the adjustment fastener 22 is tightened, the proximal support end 4 of the first wall support 1 and the proximal support end 4 of the second wall support 2 are pressed against the fulcrum ball 7. On the other hand, when the adjustment fastener 22 is loosened, the proximal support end 4 of the first wall support 1 and the proximal support end 4 of the second wall support 2 release the fulcrum ball 7.

When the adjustment fastener 22 is loosened, the fulcrum ball 7 is allowed to rotate, which allows the user to adjust the orientation of the support hook 8. As can be seen in FIGS. 1 through 10, the hourglass-shaped channel 16 comprises a first channel slot 17, a second channel slot 18, and a channel throat 19. The first channel slot 17 and the second channel slot 18 correspond to two opposite slots about the fulcrum ball 7 that allow the adjustment fastener 22 to pass through the fulcrum ball 7. Further, the first channel slot 17 traverses out of the fulcrum ball 7, adjacent to the first fastener hole 20, to allow the adjustment fastener 22 to enter the hourglass-shaped channel 16. In addition, the second channel slot 18 traverses out of the fulcrum ball 7, adjacent to the second fastener hole 21, to allow the adjustment fastener 22 to exit the hourglass-shaped channel 16 and pass through the second fastener hole 21.

Further, the hourglass-shaped channel 16 is designed in such a way that a limited range of rotation is allowed for the fulcrum ball 7, as can be seen in FIGS. 1 through 10. The area adjacent to the first channel slot 17 is shaped as a converging cone with a wider space adjacent to the first channel slot 17 and a smaller space adjacent to the channel throat 19. Similarly, the area adjacent to the second channel slot 18 is shaped as a diverging cone with a wider space adjacent to the second channel slot 18 and a smaller space adjacent to the channel throat 19. Further, the channel throat 19 is centrally positioned in between the first channel slot 17 and the second channel slot 18, preferably adjacent to the center of the fulcrum ball 7. This way, when the adjustment fastener 22 is positioned through the hourglass-shaped channel 16, the fulcrum ball 7 can rotate until the adjustment fastener 22 reaches the opposite walls of the hourglass-shaped channel 16. In other embodiments, the hourglass-shaped channel 16 can be altered to allow a different range of rotation of the fulcrum ball 7.

As previously discussed, the support hook 8 is designed to engage a portion of the hunting trophy to secure the hunting trophy to the support hook 8. In general, the support hook 8 is an L-shaped hook big enough to engage the desired portion of the hunting trophy. So, the support hook 8 comprises a hook shaft portion 9 and a hook catch portion 12 corresponding to the two integral portions of the L-shaped support hook 8, as can be seen in FIGS. 1 through 10. In addition, the hook shaft portion 9 comprises a proximal shaft end 10 and a distal shaft end 11 corresponding to the terminal ends of the hook shaft portion 9. To implement this embodiment of the support hook 8, the proximal shaft end 10 is connected onto the fulcrum ball 7, offset from the hourglass-shaped channel 16, to secure the hook shaft portion 9 to the fulcrum ball 7. The hook shaft portion 9 is also positioned normal to a tangent plane 23 between the proximal shaft end 10 and the fulcrum ball 7 to accommodate different features of the hunting trophy. Furthermore, the hook catch portion 12 is connected onto the distal shaft end 11 to form the L-shaped support hook 8.

In addition, to facilitate the engagement of the portion of the hunting trophy to the support hook 8, the hook catch portion 12 may comprise a sharper lateral section 13 and a rounded lateral section 14, as can be seen in FIGS. 1 through 10. The sharper lateral section 13 and the rounded lateral section 14 are designed to facilitate the engagement of the hook catch portion 12 with notches or smaller sections of the hunting trophy. In the preferred embodiment, the sharper lateral section 13 and the rounded lateral section 14 are positioned opposite to each other about the hook catch portion 12. The sharper lateral section 13 and the rounded lateral section 14 preferably correspond to two opposite sides of the hook catch portion 12. Further, the sharper lateral section 13 is oriented towards the fulcrum ball 7, while the rounded lateral section 14 is oriented away the fulcrum ball 7. This way, the engaged portion of the hunting trophy is secured between the sharper lateral section 13 and the fulcrum ball 7. In other embodiments, different mechanisms can be used to engage the portion of the hunting trophy.

In some embodiments, the support hook 8 further may further comprise a tethering hole 24 that allows the use of a tether to secure the hunting trophy to the support hook 8, as can be seen in FIG. 24. The tethering hole 24 can be large enough to accommodate different types of tethers including, but not limited to, wire, string, fishing line, etc. Further, the tethering hole 24 prevents unwanted rotation of the mounted hunting trophy so that the hunting trophy is held at an unbalanced trophy head level. This can also be achieved using a dowel pin or button head screws inserted into the tethering hole 24 in such a way that the fasteners protrude out each side. To implement the tethering hole 24, the tethering hole 24 laterally traverses through the hook shaft portion 9, adjacent to the proximal shaft end 10. This way, when the chosen tether is inserted through the tethering hole 24, the chosen tether does not obstruct the engagement of the sharper lateral section 13 with the target portion of the hunting trophy. In other embodiments, different mechanisms can be implemented to further secure the hunting trophy and to prevent rotation/leveling the mounted hunting trophy.

As previously, different types of tethers can be inserted through the tethering hole 24. In some embodiment, the present invention may further comprise a mounting wire 25 that can be inserted through the tethering hole 24, as can be seen in FIG. 25. For example, the mounting wire 25 can be looped through the tethering hole 24 and a section of the hunting trophy to secure the hunting trophy to the support hook 8. In other embodiments, different tethering devices can be implemented.

As previously discussed, the present invention is designed to be secured to a wall to display the hunting trophy. As can be seen in FIGS. 1 through 10, the first wall support 1 and the second wall support 2 may each further comprise a wall-mounting fastener hole 6. The wall-mounting fastener hole 6 allows the fastening of each wall support to the desired wall. To do so, the wall-mounting fastener hole 6 traverses through the elongated support body 3 and out of the distal support end 5. This way, the first wall support 1 and the second wall support 2 can be fastened to the desired wall using two appropriate fasteners.

To ensure that the present invention is evenly and securely fastened to the target wall, each wall-mounting fastener hole 6 is implemented in such a way that no unnecessary torque is applied to either of the wall supports. In the preferred embodiment, the wall-mounting fastener hole 6 of the first wall support 1 is positioned perpendicular to the adjustment fastener 22 of the ball-adjustment mechanism 15, as can be seen in FIGS. 1 through 10. Similarly, the wall-mounting fastener hole 6 of the second wall support 2 is positioned perpendicular to the adjustment fastener 22 of the ball-adjustment mechanism 15. This way, the adjustment fastener 22 is kept parallel to the wall when the present invention is secured to the wall. Furthermore, the wall-mounting fastener hole 6 of the first wall support 1 and the wall-mounting fastener hole 6 of the second wall support 2 are positioned parallel to each other to prevent unnecessary torque on the adjustment fastener 22. In other embodiments, different fastening mechanisms can be implemented that secure the wall supports to the target wall.

Although the invention has been explained in relation to its preferred embodiment, it is to be understood that many other possible modifications and variations can be made without departing from the spirit and scope of the invention.

What is claimed is:

1. An adjustable trophy wall mount comprising:
a first wall support;
a second wall support;
a fulcrum ball;
a support hook;
a ball-adjustment mechanism;
the first wall support and the second wall support each comprising an elongated support body, a proximal support end, and a distal support end;
the proximal support end and the distal support end being positioned opposite to each other along the elongated support body;
the proximal support end of the first wall support and the proximal support end of the second wall support being pivotably mounted onto the fulcrum ball;
the proximal support end of the first wall support and the proximal support end of the second wall support being positioned opposite to each other about the fulcrum ball;
the support hook being connected onto the fulcrum ball in between the proximal support end of the first wall support and the proximal support end of the second wall support; and
the ball-adjustment mechanism being operatively integrated through the proximal support end of the first wall support, the proximal support end of the second wall support, and the fulcrum ball, wherein the ball-adjustment mechanism is used to loosen an arrangement between the proximal support end of the first wall support, the proximal support end of the second wall support, and the fulcrum ball in order to adjust an orientation of the support hook and is further used to tighten the arrangement between the proximal support end of the first wall support, the proximal support end of the second wall support, and the fulcrum ball in order to secure the support hook in place.

2. The adjustable trophy wall mount as claimed in claim 1 further comprising:
the ball-adjustment mechanism comprising an hourglass-shaped channel, a first fastener hole, a second fastener hole, and an adjustment fastener;
the hourglass-shaped channel traversing through the fulcrum ball;
the first fastener hole laterally traversing through the elongated support body of the first wall support, adjacent to the proximal support end of the first wall support;
the second fastener hole laterally traversing through the elongated support body of the second wall support, adjacent to the proximal support end of the second wall support; and
the adjustment fastener being positioned through the first fastener hole, through the hourglass-shaped channel, and through the second fastener hole.

3. The adjustable trophy wall mount as claimed in claim 2 further comprising:
the hourglass-shaped channel comprising a first channel slot, a second channel slot, and a channel throat;
the first channel slot traversing out of the fulcrum ball, adjacent to the first fastener hole;
the second channel slot traversing out of the fulcrum ball, adjacent to the second fastener hole; and
the channel throat being centrally positioned in between the first channel slot and the second channel slot.

4. The adjustable trophy wall mount as claimed in claim 1 further comprising:
the support hook comprising a hook shaft portion and a hook catch portion;
the hook shaft portion comprising a proximal shaft end and a distal shaft end;
an hourglass-shaped channel of the ball-adjustment mechanism traversing through the fulcrum ball;
the proximal shaft end being connected onto the fulcrum ball, offset from the hourglass-shaped channel;
the hook shaft portion being positioned normal to a tangent plane between the proximal shaft end and the fulcrum ball; and
the hook catch portion being connected onto the distal shaft end.

5. The adjustable trophy wall mount as claimed in claim 4 further comprising:
the support hook further comprising a tethering hole; and
the tethering hole laterally traversing through the hook shaft portion, adjacent to the proximal shaft end.

6. The adjustable trophy wall mount as claimed in claim 5 further comprising:
a mounting wire; and
the mounting wire being looped through the tethering hole.

7. The adjustable trophy wall mount as claimed in claim 4 further comprising:
the hook catch portion comprising a sharper lateral section and a rounded lateral section;
the sharper lateral section and the rounded lateral section being positioned opposite to each other about the hook catch portion;
the sharper lateral section being oriented towards the fulcrum ball; and
the rounded lateral section being oriented away the fulcrum ball.

8. The adjustable trophy wall mount as claimed in claim 1 further comprising:
the first wall support and the second wall support each further comprising a wall-mounting fastener hole; and
the wall-mounting fastener hole traversing through the elongated support body and out of the distal support end.

9. The adjustable trophy wall mount as claimed in claim 8 further comprising:
the wall-mounting fastener hole of the first wall support being positioned perpendicular to an adjustment fastener of the ball-adjustment mechanism;
the wall-mounting fastener hole of the second wall support being positioned perpendicular to the adjustment fastener of the ball-adjustment mechanism; and
the wall-mounting fastener hole of the first wall support and the wall-mounting fastener hole of the second wall support being positioned parallel to each other.

10. An adjustable trophy wall mount comprising:
a first wall support;
a second wall support;
a fulcrum ball;
a support hook;
a ball-adjustment mechanism;
the first wall support and the second wall support each comprising an elongated support body, a proximal support end, and a distal support end;
the ball-adjustment mechanism comprising an hourglass-shaped channel, a first fastener hole, a second fastener hole, and an adjustment fastener;
the proximal support end and the distal support end being positioned opposite to each other along the elongated support body;
the proximal support end of the first wall support and the proximal support end of the second wall support being pivotably mounted onto the fulcrum ball;
the proximal support end of the first wall support and the proximal support end of the second wall support being positioned opposite to each other about the fulcrum ball;
the support hook being connected onto the fulcrum ball in between the proximal support end of the first wall support and the proximal support end of the second wall support;
the hourglass-shaped channel traversing through the fulcrum ball;
the first fastener hole laterally traversing through the elongated support body of the first wall support, adjacent to the proximal support end of the first wall support;
the second fastener hole laterally traversing through the elongated support body of the second wall support, adjacent to the proximal support end of the second wall support; and
the adjustment fastener being positioned through the first fastener hole, through the hourglass-shaped channel, and through the second fastener hole.

11. The adjustable trophy wall mount as claimed in claim 10 further comprising:
the hourglass-shaped channel comprising a first channel slot, a second channel slot, and a channel throat;
the first channel slot traversing out of the fulcrum ball, adjacent to the first fastener hole;
the second channel slot traversing out of the fulcrum ball, adjacent to the second fastener hole; and
the channel throat being centrally positioned in between the first channel slot and the second channel slot.

12. The adjustable trophy wall mount as claimed in claim 10 further comprising:
the support hook comprising a hook shaft portion and a hook catch portion;
the hook shaft portion comprising a proximal shaft end and a distal shaft end;
an hourglass-shaped channel of the ball-adjustment mechanism traversing through the fulcrum ball;
the proximal shaft end being connected onto the fulcrum ball, offset from the hourglass-shaped channel;
the hook shaft portion being positioned normal to a tangent plane between the proximal shaft end and the fulcrum ball; and
the hook catch portion being connected onto the distal shaft end.

13. The adjustable trophy wall mount as claimed in claim 12 further comprising:
a mounting wire;
the support hook further comprising a tethering hole;
the tethering hole laterally traversing through the hook shaft portion, adjacent to the proximal shaft end; and
the mounting wire being looped through the tethering hole.

14. The adjustable trophy wall mount as claimed in claim 13 further comprising:
the hook catch portion comprising a sharper lateral section and a rounded lateral section;
the sharper lateral section and the rounded lateral section being positioned opposite to each other about the hook catch portion;
the sharper lateral section being oriented towards the fulcrum ball; and
the rounded lateral section being oriented away the fulcrum ball.

15. The adjustable trophy wall mount as claimed in claim 10 further comprising:
the first wall support and the second wall support each further comprising a wall-mounting fastener hole;
the wall-mounting fastener hole traversing through the elongated support body and out of the distal support end;
the wall-mounting fastener hole of the first wall support being positioned perpendicular to an adjustment fastener of the ball-adjustment mechanism;
the wall-mounting fastener hole of the second wall support being positioned perpendicular to the adjustment fastener of the ball-adjustment mechanism; and
the wall-mounting fastener hole of the first wall support and the wall-mounting fastener hole of the second wall support being positioned parallel to each other.

16. An adjustable trophy wall mount comprising:
a first wall support;
a second wall support;
a fulcrum ball;
a support hook;
a ball-adjustment mechanism;
the first wall support and the second wall support each comprising an elongated support body, a proximal support end, and a distal support end;
the ball-adjustment mechanism comprising an hourglass-shaped channel, a first fastener hole, a second fastener hole, and an adjustment fastener;
the hourglass-shaped channel comprising a first channel slot, a second channel slot, and a channel throat;
the proximal support end and the distal support end being positioned opposite to each other along the elongated support body;
the proximal support end of the first wall support and the proximal support end of the second wall support being pivotably mounted onto the fulcrum ball;
the proximal support end of the first wall support and the proximal support end of the second wall support being positioned opposite to each other about the fulcrum ball;
the support hook being connected onto the fulcrum ball in between the proximal support end of the first wall support and the proximal support end of the second wall support;
the hourglass-shaped channel traversing through the fulcrum ball;
the first fastener hole laterally traversing through the elongated support body of the first wall support, adjacent to the proximal support end of the first wall support;
the second fastener hole laterally traversing through the elongated support body of the second wall support, adjacent to the proximal support end of the second wall support;
the adjustment fastener being positioned through the first fastener hole, through the hourglass-shaped channel, and through the second fastener hole;
the first channel slot traversing out of the fulcrum ball, adjacent to the first fastener hole;
the second channel slot traversing out of the fulcrum ball, adjacent to the second fastener hole; and
the channel throat being centrally positioned in between the first channel slot and the second channel slot.

17. The adjustable trophy wall mount as claimed in claim 16 further comprising:
the support hook comprising a hook shaft portion and a hook catch portion;
the hook shaft portion comprising a proximal shaft end and a distal shaft end;
an hourglass-shaped channel of the ball-adjustment mechanism traversing through the fulcrum ball;
the proximal shaft end being connected onto the fulcrum ball, offset from the hourglass-shaped channel;
the hook shaft portion being positioned normal to a tangent plane between the proximal shaft end and the fulcrum ball; and
the hook catch portion being connected onto the distal shaft end.

18. The adjustable trophy wall mount as claimed in claim 17 further comprising:
a mounting wire;
the support hook further comprising a tethering hole;
the tethering hole laterally traversing through the hook shaft portion, adjacent to the proximal shaft end; and
the mounting wire being looped through the tethering hole.

19. The adjustable trophy wall mount as claimed in claim 17 further comprising:
the hook catch portion comprising a sharper lateral section and a rounded lateral section;
the sharper lateral section and the rounded lateral section being positioned opposite to each other about the hook catch portion;
the sharper lateral section being oriented towards the fulcrum ball;
the rounded lateral section being oriented away the fulcrum ball;

20. The adjustable trophy wall mount as claimed in claim 16 further comprising:
the first wall support and the second wall support each further comprising a wall-mounting fastener hole;
the wall-mounting fastener hole traversing through the elongated support body and out of the distal support end;
the wall-mounting fastener hole of the first wall support being positioned perpendicular to an adjustment fastener of the ball-adjustment mechanism;
the wall-mounting fastener hole of the second wall support being positioned perpendicular to the adjustment fastener of the ball-adjustment mechanism; and
the wall-mounting fastener hole of the first wall support and the wall-mounting fastener hole of the second wall support being positioned parallel to each other.
